(19) United States
(12) Patent Application Publication
(10) Pub. No.: US 2010/0098426 A1
(43) Pub. Date: Apr. 22, 2010

(54) Electro-Optical Power Level Controller for Free-Space Optical Communication Links

(76) Inventors: John P. Cornish, Manteca, CA (US); Anthony J. Ruggiero, Livermore, CA (US); Gary W. Johnson, Livermore, CA (US)

Correspondence Address: LLNS / John P. Wooldridge;John H. Lee, Assistant Laboratory Counsel, L-703, P.O Box 808, Livermore, CA, 94551, US

(21) Appl. No.: 12/256,364

(22) Filed: Oct. 22, 2008

(51) Int. Cl. H04B 10/00

(52) U.S. Cl. 398/118

(57) ABSTRACT

Systems and methods are described for automatically controlling the received power in an optical fiber connected to a free-space optical communications terminal. The system effectively reduces the dynamic range of the received light, enhancing the performance of the communications channel in the face of wide power swings induced by atmospheric scintillation and beam pointing jitter.

The United States Government has rights In this invention pursuant to Contract No. DE-AC52-07NA27344 between the United States Department of Energy and Lawrence Livermore National Security, LLC.

### BACKGROUND OF THE INVENTION

1. Field of the Invention

The present invention relates to free-space optical communication systems, and more specifically, it relates to techniques for adjustment of received power just prior to delivery to the photoreceiver in a free-space optical communication systems.

2. Description of Related Art

In free-space laser communications, atmospheric scintillation causes rapid and highly dynamic fluctuations in received optical power. This is in addition to slower variations in power due to variable range between transmitter and receiver (if one or both systems are mobile), and other propagation loss variables. The sum of these variations demands an extreme dynamic range on the part of the communications photoreceiver, often beyond the state of the art of such receivers. Prior art uses adjustment of transmitter power or adjustment of beam focus at the transmit or receive end to account for some of the power variation. However, those methods are relatively slow, typically <1 Hz bandwidth, whereas the scintillation generates variations in excess of several hundred Hz.

### SUMMARY OF THE INVENTION

It is an object of the present invention to utilizes a semiconductor optical amplifier as a variable optical attenuator to provide very fast (kHz to MHz) adjustment of received power just prior to delivery to the photoreceiver.

Another object, is to provide a MEMS variable optical attenuator that serves a similar purpose, but operates on multimode fiber.

These and other objects will be apparent based on the disclosure herein.

A system is described for automatically controlling the received power in an optical fiber connected to a free-space optical communications terminal. The system effectively reduces the dynamic range of the received light, enhancing the performance of the communications channel, in the face of wide power swings induced, by atmospheric scintillation and beam, pointing jitter, Two embodiments are described. The first uses a semiconductor optical amplifier, acting on light in a single-mode fiber. The second embodiment uses a MEMS variable optical attenuator acting on light in a multimode fiber. For either embodiment, feedback is derived from an optical power detector that samples a fraction of the received power. Feedback can also be derived from the photocurrent of a photodiode that also serves as the communication data receiver.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows a family of gain curves for the Alcatel non gain-clamped SOA.

FIG. 2 shows a feedback topology for the active SOA automatic level control.

FIG. 3 shows transfer characteristics of the AGC (automatic gain control) system in active and passive modes.

FIG. 4 shows contrast effects of the AGC system in active mode.

FIG. 5 shows a bit error rate test with 500 Hz bandwidth turbulence-modulated input intensity.

FIG. 6 shows a multimode VOA controller.

FIG. 7A shows a schematic of an analog circuit designed as a controller for use with the multimode VOA of the present invention.

FIGS. 7B-D show magnified views of the schematic of FIG. 7A.

### DETAILED DESCRIPTION OF THE INVENTION

### Semiconductor Optical Amplifier Embodiment

An optical automatic level control based on a gain-clamped semiconductor optical amplifier (SOA) has been demonstrated. SOAs are solid-state optical amplifiers for use with near-Infrared, wavelengths and are operable only with single-mode fiber. To the first order, SOA gain is roughly proportional to applied electrical current, thus making it usable as an optical, gain control element when used with an active feedback circuit. Another useful SOA property is that its output power is finite and dependent upon the electrical current. That means that it automatically limits the output power in spite of further increases of input power. This is a kind of passive level control. In the passive mode, the present inventors demonstrated a compression ratio of 1.6 with a bandwidth extending into the GHz range. With a simple feedback controller, the compression ratio improved to 2.3 at low frequencies.

SOA Characterization

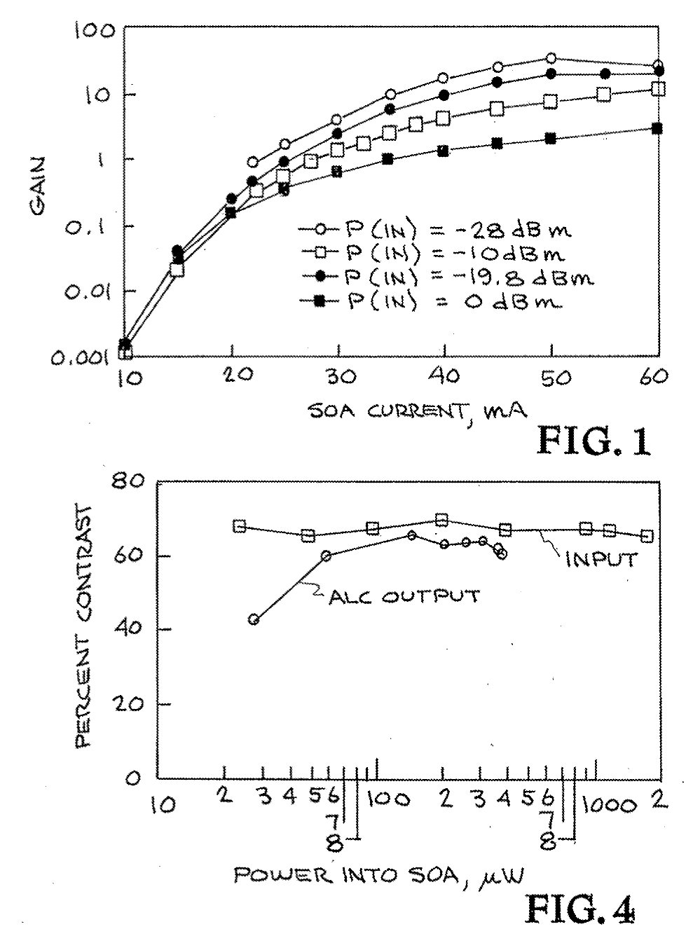

Gain performance of an Alcatel model 1921 gain-clamped SOA was evaluated on an optical bench. FIG. 1 shows the nonlinear behavior of this device, with gain being a function of both the operating current as well as the input optical power. Gain is also a function of temperature (not characterized here), so the device is operated at constant temperature. In general, the device acts as a compressor, where increased input power results in decreased gain. From these curves, it was decided that an operating current around 30 mA is desirable to obtain a typical gain of one while allowing a reasonable gain adjustment range through current modulation. Maximum power gain (at high current and low input power) is 14 dB. At lower currents, the device behaves as an attenuator, as expected.

SOA Automatic Level Control System

Two modes of operation are possible when using an SOA for optical level control: passive, where the SOA operates at a constant current, and active, where a control system adjusts the current in an attempt to regulate the optical output power. The passive mode is a picture of simplicity: insert the SOA in a fiber-coupled system, and set the current, lire active mode requires a feedback or feedforward controller. Typical AGC systems use feedback because the transfer characteristics of the control element (the SOA) need not be exceptionally stable. The disadvantage of most feedback systems is potential instability. Feedforward systems are generally easier to stabilize, but require detailed knowledge of the control element's transfer characteristics. Considering the multivariate nonlinear response of the SOA, feedback is much more practical.

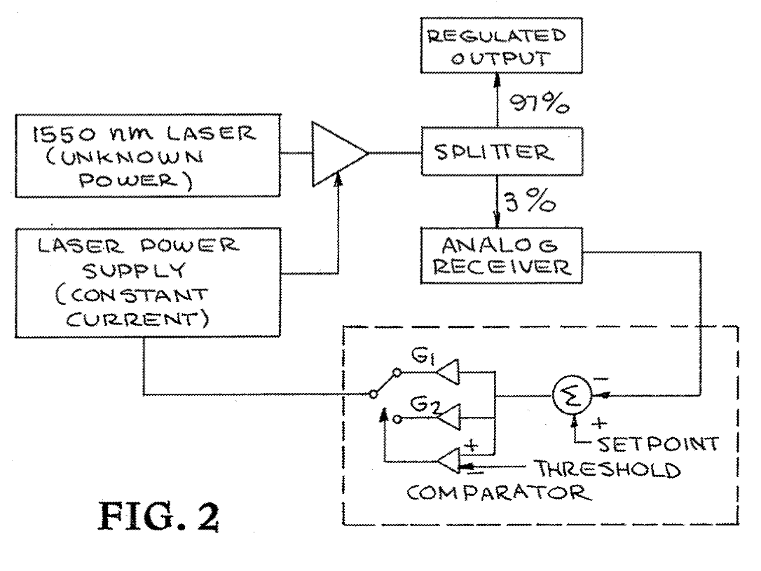

The feedback topology Initially chosen was a proportional controller with a first-order lowpass response. It is easy to tune and is adequate for tracking dynamic process variables. Feedback was derived from a New Focus 2011 photoreceiver with low noise, adjustable gain, a maximum 200 kHz bandwidth, and an adjustable first-order lowpass filter that served as the loop compensation filter. Loop gain and user-supplied setpoint entry was implemented on a single-board DSP system (Innovative Integration SBC32) with oil-board 16-bit A/D and D/A converters capable of running at 100 kHz, Programming was done in a graphical DSP development language (Hypersignal RIDE). FIG. 2 shows a feedback topology for an active SOA automatic level control.

SOA AGC Performance

The AGC system was installed in a fiber-coupled testbed consisting of a 1550 nm DFB laser, two amplitude modulators, the AGC, and photoreceivers at the output. The modulators were Mach-Zehnder types (UTP MZ-150-030) with 3 GHz bandwidth. The first modulator was used to vary the incident laser intensity at low frequencies to obtain the system transfer characteristic. The second modulator was driven by a digital pattern generator during bit error rate (BEE) testing.

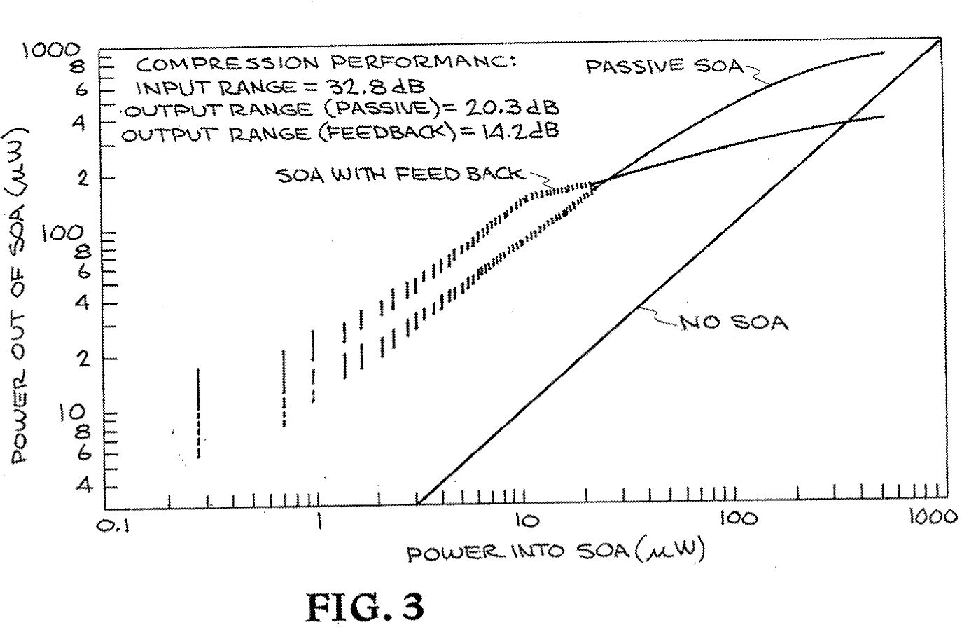

FIG. 3 summarizes the transfer characteristics of the AGC system with and without feedback. When used passively at a constant current of 30 mA, an input range of 32.7 dB was compressed to an output range of 203 dB, for a compression factor of 1.6. A “perfect” AGC would have an infinite compression ratio, resulting in a horizontal line on the graph.

The feedback system had to be adjusted to avoid oscillation while maximizing compression. A breakpoint in the feedback gain helped to some degree, allowing a gain up to four times higher at low power than at high power. This is a first-order compensation for the gain nonlinearity of the SOA. Ideally, a nonlinear feedback function could be developed that optimizes the loop gain for best compression without instability. With the inventors best settings, the output power setpoint was 150 μW, the crossover point was 150 μW, and the loop filter cutoff frequency was 1 kHz. The gain breakpoint is clearly visible in FIG. 3, which shows transfer characteristics of the AGC system in active and passive modes. An input range of 32.7 dB was compressed to an output range of 14.2 dB, for a compression factor of 2.3. The compression is much more effective when the input is above 10 μW, attaining a 4:1 ratio.

The purpose of an AGC system is to reduce variations in out put power. But this may lead to the deleterious side effect of reducing the contrast, in an amplitude-modulated signal. Furthermore, since the SOA passively compresses the signal with a response time under 1 ns, even very high speed modulation waveforms could be corrupted. The inventors measured contrast with this AGC system (without feedback) with a square wave AM signal having about 68% contrast FIG. 4 shows that the loss of contrast through the AGC is only a few percent for input power levels above 50 μW. At very low input power, contrast is reduced, which may compromise AM communications. Phase- or frequency-modulated signals are of course unaffected by the AGC, Contrast behavior was invariant from 10 Hz to 50 MHz.

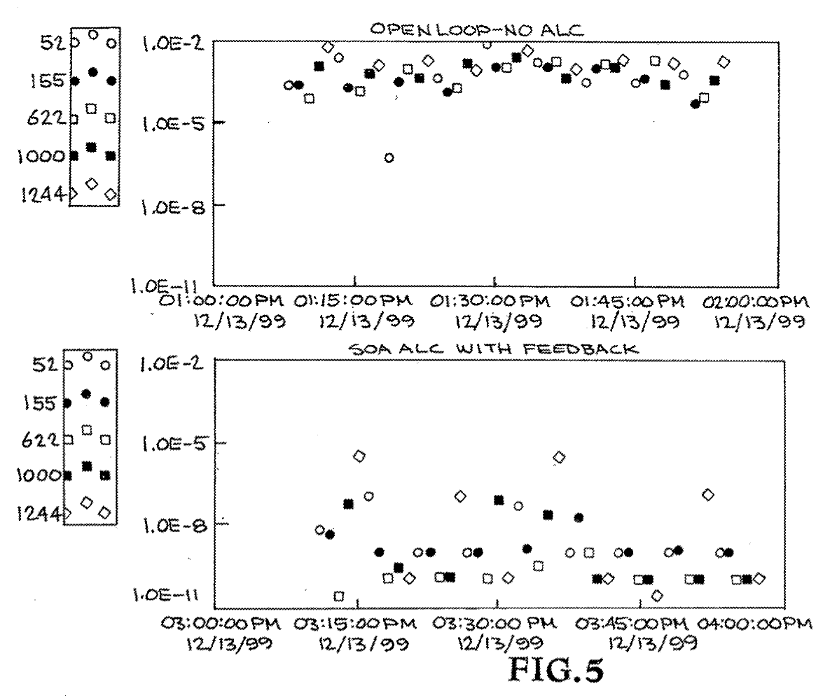

A bit error rate (BER) test was performed to evaluate the AGC system under realistic conditions that might be encountered in free-space laser communications. The first amplitude modulator was driven by a random-amplitude signal that was previously recorded from the received power on a 1.3 km laser communications link. The second modulator was driven by a digital pattern generator (Anritsu 1370) at several modulation frequencies up to 1244 Mbps. The AGC output fed a telecommunications receiver (Optobahn) which was connected to an Anritsu 1371 bit error rate tester. FIG. 5 compares the BER with and without the AGC system, using the same 50 minutes of recorded intensity data. Measurement without the AGC are typical of the inventors' experience with the actual 1.3 km link—10⁻³ error rates are generally observed under conditions of high turbulence. The AGC improved the average BER by six orders of magnitude.

Feedback Controller Options

Frequency response of an active SOA AGC system test was limited to a bandwidth of about 300 Hz because of the 150 μs delay time induced by the DSP controller. Converting to an analog controller could yield much greater bandwidth because the SOA itself is fast (<1 ns delay) and the other elements in the control loop (photoreceiver and current driver) can also be designed for wide bandwidth. Even without such a controller, the passive compression provided by the SOA continues to operate at high frequencies.

Feedback from Photoreceiver Current

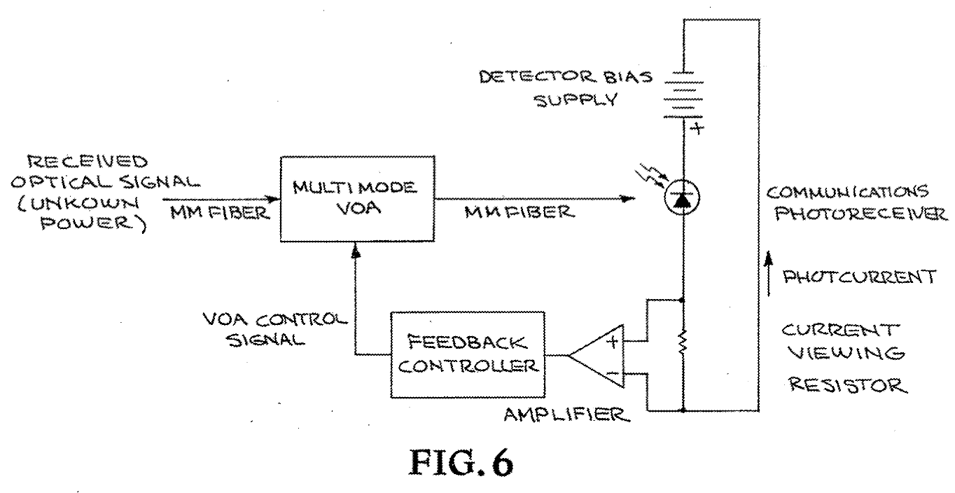

As previously described, feedback has been successfully derived from a fiber optic power splitter and a dedicated power measurement photoreceiver. The drawback of that method is that extra components (splitter and photoreceiver) are required, and there is additional loss of received power that otherwise would feed the data communications photoreceiver. A solution is to use the photocurrent of the communications photoreceiver as the measurement (FIG. 6). In all photodiodes, the average current through the device is linearly proportional to the incident power over several decades. To sense this current, a current viewing resistor (shunt) is inserted, in series with the photodiode, A differential amplifier increases the signal level to suit the needs of the feedback controller.

### Multimode VOA Embodiment

In FSO applications, it is often more efficient to couple received light into multimode fiber. Such fiber can have a larger core and will accept the many scrambled propagation modes that occur when laser light scintillates in the atmosphere. Since SOAs are not usable with multimode fiber, a different kind of power adjustment device, a variable optical attenuator (VOA), was chosen. However, there were no commercial VOAs with sufficiently fast response time to act upon the >200 Hz bandwidth required by atmospheric scintillation. Therefore, a custom multi mode-capable variable optical attenuator was fabricated to the inventors' specification by Lightconnect, Inc. (Newark, Calif.) [Ref. 1]. The device uses micro electro-mechanical system (MEMS) technology to form a diffractive structure. When a small voltage is applied to the electrodes, an element moves, changing the coupling between the input and output fibers. Thus, the attenuation, is a function of voltage. Attenuation is highly nonlinear with respect to voltage, which can complicate its use in a control loop. Response time is on the order of 10 s of microseconds for large steps, which is fast enough to keep up with events associated with atmospheric turbulence. The internal design of the new VOA was an adaptation of prior art that is property of Lightconnect. The use of this method with multimode fiber is novel. Also, use of this method in the receiver portion of a free-space optical communication system is novel.

Multimode VOA Controller

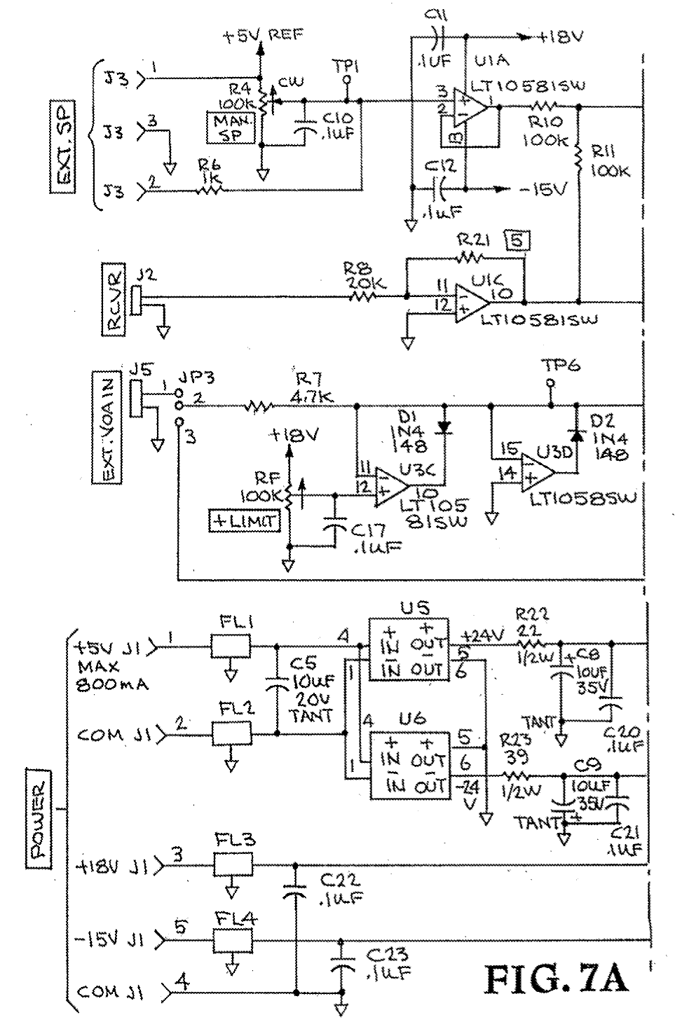

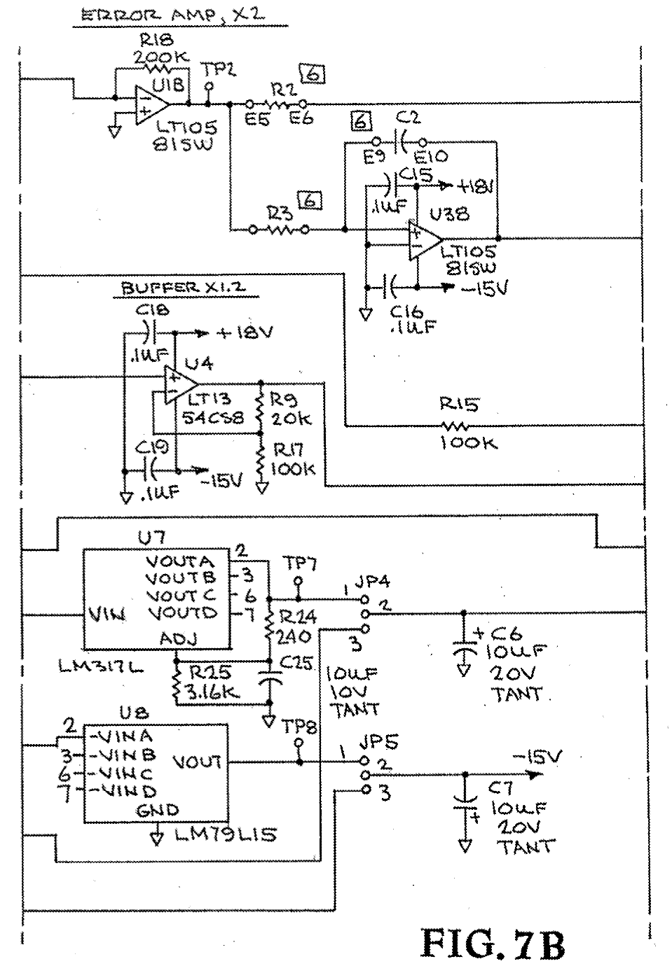

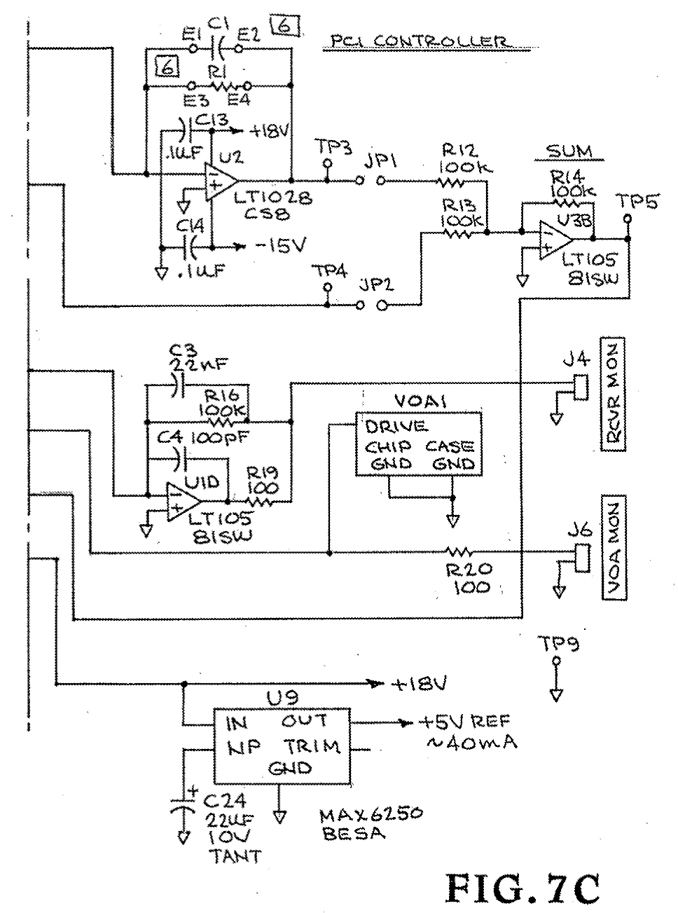

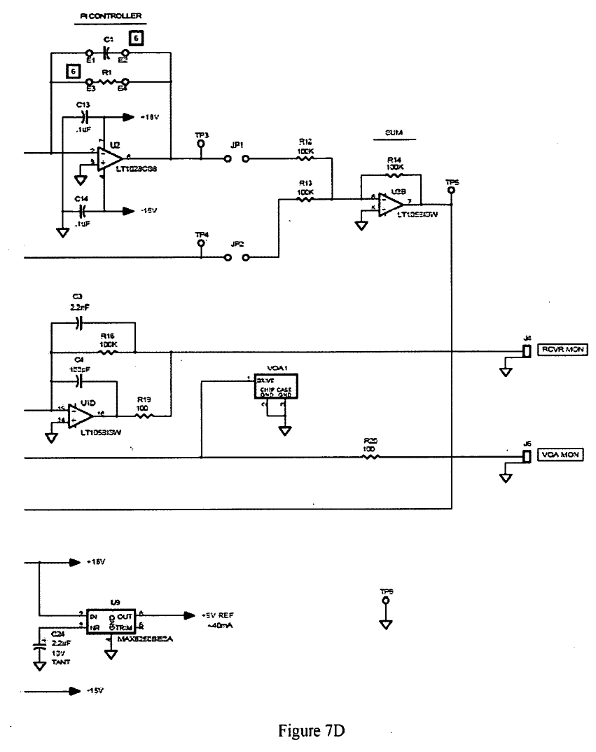

An analog circuit was designed as a controller for use with the multimode VOA (LLNL drawing LEA03-118401, incorporated herein, by reference). The complete schematic is shown in FIG. 7A, FIGS. 7B-D show magnified views of the schematic of FIG. 7A. It is also suitable for use with an SOA control element. The control path consists of the following blocks: 1. Receiver amplifier. Scales the photodiode current measurement. 2. Error amplifier. Compares photodiode current with a setpoint voltage. 3, Integrator, Integrates the error. Optionally, a proportional gain stage may be also selected, producing any combination of proportional and integral control strategies. 4. Limiter. The integrator output passes through a limiting circuit that prevents the command voltage to the VOA from exceeding the device's safe limits. 5. Driver amplifier. Provides sufficient voltage and current to drive the VOA.

In another embodiment, the controller is implemented digitally. The measurement of photocurrent is digitized by an A/D converter, then the proportional/integral control strategy is implemented through software in a microcontroller. The result feeds a D/A converter which drives the multimode VOA.

Accordingly, an embodiment of the invention is a free space optical data communication method, comprising: receiving incoming light at a telescope, the incoming light encoded with data and traversing an atmospheric free space optical path to the telescope, wherein a phase of a wavefront of the incoming light is at least partially pre-corrected before traversing the atmospheric free space optical path; sensing the wavefront of the incoming light encoded with data and at least partially correcting the phase of the wavefront; optically attenuating the incoming light; detecting art average power level of the attenuated light; generating a voltage that is approximately a log function of an average power level of the attenuated light; and varying the optical attenuation approximately as an exponential function of the voltage to adaptively regulate the average power level of the incoming light in response to variations in a loss of the atmospheric free space optical path. The regulated average power level can be maintained within a predefined power range.

Another embodiment is a receiver for an adaptive optics free space optical communication system, the receiver comprising: an optical telescope for receiving incoming light encoded, with data, the incoming light traversing an atmospheric free space optical path to the telescope, wherein a phase of a wavefront of the incoming light is at least partially pre-corrected via an adjustable phase device before traversing the atmospheric free space optical path; an adaptive optical power regulator optically coupled with the optical telescope for adaptively regulating an average power level of the incoming light in response to variations in a loss of the atmospheric free space optical path, the adaptive optical power regulator comprising: a variable optical attenuator having a controllable attenuation for optically attenuating the incoming light; an optical tap detector positioned to detect the average power level of the attenuated light, the optical tap detector generating a voltage that is approximately a log function of the average power level of the attenuated light; and a controller coupled to the optical tap detector and the variable optical attenuator, the controller varying the optical attenuation approximately as an exponential function of the voltage to adaptively regulate the optical attenuation in response to the detected average power level; and an adaptive optics system optically coupled with the optical telescope for sensing the wavefront of the incoming light encoded with data and at least partially correcting the phase of the wavefront. The adaptive optical power regulator is fast enough to at least partially compensate for scintillation-induced variations in the average power level. The adaptive optical power regulator may have a response time of 0.2 milliseconds or faster. The adaptive optical power regulator can have sufficient dynamic range to compensate for fog-induced variations in the average power level. The adaptive optical power regulator can have a dynamic range of at least 20 dB. The adaptive optical power regulator can be programmable.

Another embodiment is an adaptive optics free space optical communication system comprising: a first transceiver and a second transceiver for bidirectionally transmitting light encoded with data across an atmospheric free space optical path, wherein: each transceiver comprises an optical telescope for receiving incoming light encoded, with data transmitted by the other transceiver; the first transceiver comprises an adaptive optical power regulator optically coupled with the optical telescope for adaptively regulating an average power level of the incoming light in response to variations in a loss of the atmospheric free space optical path, the adaptive optical power regulator comprising: a variable optical attenuator having a controllable attenuation for optically attenuating the incoming light; an optical tap detector positioned to detect the average power level of the attenuated light, the optical tap detector generating a voltage that is approximately a log function of the average power level of the attenuated light; a controller coupled to the optical tap detector and the variable optical attenuator, the controller varying the optical attenuation approximately as an exponential, function, of the voltage to adaptively regulate the optical attenuation in response to the detected average power level; the first transceiver comprises an adaptive optics system optically coupled with the optical telescope for sensing the wavefront of the incoming light encoded with data and at least partially correcting a phase of the wavefront; and the second transceiver comprises an adaptive optics system optically coupled with the optical telescope for at least partially pre-correcting the phase of the wavefront of the light encoded with data to be transmitted to the first transceiver.

In another embodiment, a free space optical data communication method, comprises: at least partially pre-correcting a phase of a waveficont of data-encoded light in response to aberrations along a free space optical path between two transceivers; transmitting the partially pre-corrected data-encoded light across the free space optical path; receiving the transmitted data-encoded light; at least partially correcting a phase of a wavefront of the received data-encoded light in response to aberrations along the free space optical path; optically attenuating the received data-encoded light; detecting an average power level of the attenuated light; generating a voltage that is approximately a log function of an average power level of the attenuated light; and varying the optical attenuation approximately as an exponential function of the voltage to adaptively regulate the power level of the received, data-encoded light in response to time-varying losses along the free space optical path.

Another embodiment is an adaptive optics free space optical communication system comprising: a first transceiver and a second transceiver for transmitting data-encoded light across a free space optical path from the first transceiver to the second transceiver, wherein: the first transceiver comprises: an adaptive optics system for at least partially pre-correcting a phase of a wavefront of data-encoded light in response to aberrations along the free space optical path; and the second transceiver comprises: an adaptive optics system for at least partially correcting a phase of a wavefront of the received data-encoded light in response to aberrations along the free space optical path; and an adaptive optical power regulator for adaptively regulating a power level of the received data-encoded light in response to variations in a loss of the free space optical path, the adaptive optical power regulator comprising: a variable optical attenuator having a controllable attenuation for optically attenuating the received data-encoded light; an optical tap detector positioned to detect the average power level of the attenuated Sight, the optical tap detector generating a voltage that is approximately a log function of the average power level of the attenuated light; and a controller coupled to the optical tap detector and the variable optical attenuator, the controller varying the optical attenuation approximately as an exponential function of the voltage to adaptively regulate the optical attenuation in response to the detected average power level.

In another embodiment, a tree space optical data communication method, comprises: determining an adaptive optics wavefront correction in response to aberrations along a free space optical path between two transceivers; receiving first data-encoded light transmitted across the free space optical path and applying the adaptive optics wavefront correction to at least partially correct a phase of a wavefront of the first data-encoded light; optically attenuating the first data-encoded light; detecting an average power level of the attenuated light; generating a voltage that is approximately a log function of an average power level of the attenuated light; varying the optical attenuation approximately as an exponential function of the voltage to adaptively regulate the power level of the first data-encoded light in response to time-varying losses along the free space optical path; and applying the adaptive optics wavefront correction to at least partially pre-correct a phase of a wavefront of second light and transmitting the second light across the free space optical path.

An embodiment is a transceiver for adaptive optics free space optical communication across a free space optical path comprising: an adaptive optics system for determining an adaptive optics wavefront correction in response to aberrations along a free space optical path between two transceivers, for applying the adaptive optics wavefront correction to at least partially correct a phase of a wavefront of first data-encoded, light received across the free space optical path, and further for applying the adaptive optics wavefront correction to at least partially pre-correct a phase of a wavefront of second light to be transmitted across the free space optical path; and an adaptive optical power regulator for adaptively regulating a power level of the first data-encoded light in response to variations in a loss of the free space optical path, the adaptive optical power regulator comprising: a variable optical attenuator having a controllable attenuation for optically attenuating the first data-encoded light; an optical tap detector positioned to detect the average power level of the attenuated light, the optical tap detector generating a voltage that is approximately a log function of the average power level of the attenuated light; and a controller coupled to the optical tap detector and the variable optical attenuator, the controller varying the optical attenuation approximately as an exponential function of the voltage to adaptively regulate the optical attenuation in response to the detected average power level.

Another embodiment is system, comprising: a free-space optical communications terminal; and means for automatically regulating received power in an optical fiber, wherein said means is connected to said free-space optical communications terminal. The means can comprise a semiconductor optical amplifier (SOA). The semiconductor optical amplifier can be configured to operate as a passive power controller, without an active feedback controller. The means can comprise a variable optical attenuator (VOA). The VOA can be configured to operate on multimode optical fiber. The means can utilize received power feedback. The received power feedback can be derived from a fiber-optic power splitter and a photodetector. The received power feedback can be derived from a measurement of photocurrent in a communications photoreceiver. The system can comprise an active regulator circuit having a feedback controller that monitors received power and modulates said means.
U.S. Pat. No. 7,286,766 is incorporated herein by reference.

### OTHER REFERENCES

### Incorporated Herein by Reference

1. Lightconnect, Inc., datasheet for FVOA 3000 fast variable optical attenuator for multimode fiber, 2004. Available from http://www.lightconnect.com/products/voa_fastvoa3000.shtml
2. Newman, Eric J. and Pilotte, Matthew, “Closed-Loop Control of Variable Optical Attenuators with logarithmic Analog Processing.” Analog Devices, Inc. Analog Dialogue, Vol. 37, December 2003. Available from http://www.analog.com/library/analogDialogue/archives/37-12/voa.html
3. Bookham Technology model ATV10GC photoreceiver with integrated MEMS VOA, Datasheet available from http://www.bookham.com/documents/datasheet_ATV10GC_{—}3.pdf

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A free space optical data communication method, comprising:
receiving incoming light at a telescope, the incoming light encoded with data and traversing an atmospheric free space optical path to the telescope, wherein a phase of a wavefront of the incoming light is at least partially pre-corrected before traversing the atmospheric free space optical path;
sensing the wavefront of the incoming light encoded with data and at least partially correcting the phase of the wavefront;
optically attenuating the incoming light;
detecting an average power level of the attenuated, light;
generating a voltage that is approximately a log function of an average power level of the attenuated light; and
varying the optical attenuation approximately as an exponential function of the voltage to adaptively regulate the average power level of the incoming light in response to variations in a loss of the atmospheric free space optical path.

2. The method of claim 1 wherein the regulated average power level is maintained within a predefined power range.

3. A receiver for an adaptive optics free space optical communication system, the receiver comprising:
an optical telescope for receiving incoming light encoded with data, the incoming light traversing an atmospheric free space optical path to the telescope, wherein a phase of a wavefront of the incoming light is at least partially pre-corrected via an adjustable phase device before traversing the atmospheric free space optical path;
an adaptive optical power regulator optically coupled with the optical telescope for adaptively regulating an average power level of the incoming light in response to variations in a loss of the atmospheric free space optical path, the adaptive optical power regulator comprising:
a variable optical attenuator having a controllable attenuation for optically attenuating the incoming light;
an optical tap detector positioned to detect the average power level of the attenuated light, the optical tap defector generating a voltage that is approximately a log function of the average power level of the attenuated light; and
a controller coupled to the optical tap detector and the variable optical attenuator, the controller varying; the optical attenuation, approximately as an exponential function of the voltage to adaptively regulate the optical attenuation in response to the detected average power level; and
an adaptive optics system optically coupled with the optical telescope for sensing the wavefront of the incoming light encoded with data and at least partially correcting the phase of the wavefront.

4. The receiver of claim 3, wherein the adaptive optical power regulator is fast enough to at least partially compensate for scintillation-induced variations in the average power level.

5. The receiver of claim 3 wherein the adaptive optical power regulator has a response time of 0.2 milliseconds or faster.

6. The receiver of claim 3 wherein the adaptive optical power regulator has a sufficient dynamic range to compensate for fog-induced variations in the average power level.

7. The receiver of claim 3 wherein the adaptive optical power regulator has a dynamic range of at least 20 dB.

8. The receiver of claim 3 wherein the adaptive optical power regulator is programmable.

9. An adaptive optics free space optical communication system comprising:
a first transceiver and a second transceiver for bidirectionally transmitting light encoded with data across an atmospheric free space optical path, wherein:
each transceiver comprises an optical telescope for receiving incoming light encoded with data transmitted by the other transceiver;
the first transceiver comprises an adaptive optical power regulator optically coupled with the optical telescope for adaptively regulating an average power level of the incoming light in response to variations in a loss of the atmospheric free space optical path, the adaptive optical power regulator comprising:
a variable optical attenuator having a controllable attenuation for optically attenuating the incoming light;
an optical tap detector positioned to detect the average power level of the attenuated light, the optical tap detector generating a voltage that is approximately a log function of the average power level of the attenuated light;
a controller coupled to the optical tap detector and the variable optical attenuator, the controller varying; the optical attenuation, approximately as an exponential function of the voltage to adaptively regulate the optical attenuation in response to the detected average power level;
the first transceiver comprises an adaptive optics system, optically coupled with the optical telescope for sensing; the wavefront of the incoming light encoded with data and at least partially correcting a phase of the wavefront; and
the second transceiver comprises an adaptive optics system optically coupled with the optical telescope for at least partially pre-correcting the phase of the wavefront of the light encoded with data to be transmitted to the first transceiver.

10. A free space optical data communication method, comprising:
at least partially pre-correcting a phase of a waveficont of data-encoded light in response to aberrations along a free space optical path between two transceivers;
transmitting the partially pre-corrected data-encoded light across the free space optical path;
receiving the transmitted data-encoded light;
at least partially correcting a phase of a wavefront of the received data-encoded light in response to aberrations along the free space optical path;
optically attenuating the received data-encoded light;
detecting an average power level of the attenuated light;
generating a voltage that is approximately a log function of an average power level of the attenuated light; and
varying the optical attenuation approximately as an exponential function of the voltage to adaptively regulate the power level of the received data-encoded light in response to time-varying losses along the free space optical path.

11. An adaptive optics free space optical communication system comprising:
a first transceiver and a second transceiver for transmitting data-encoded light across a free space optical path from the first transceiver to the second transceiver, wherein:
the first transceiver comprises:
an adaptive optics system for at least partially pre-correcting a phase of a wavefront of data-encoded light in response to aberrations along the free space optical path; and
the second transceiver comprises:
an adaptive optics system for at least partially correcting a phase of a wavefront of the received data-encoded light in response to aberrations along the free space optical path; and
an adaptive optical power regulator for adaptively regulating a power level of the received data-encoded light in response to variations in a loss of the free space optical path, the adaptive optical, power regulator comprising:
a variable optical attenuator having a controllable attenuation for optically attenuating the received data-encoded light;
an optical tap detector positioned to detect the average power level of the attenuated light the optical tap detector generating a voltage that is approximately a log function of the average power level of the attenuated light;
and a controller coupled to the optical tap detector and the variable optical attenuator, the controller varying the optical, attenuation approximately as an exponential function of the voltage to adaptively regulate the optical attenuation, in response to the detected average power level.

12. A free space optical, data communication method, comprising:
determining an adaptive optics wavefront correction in response to aberrations along a free space optical path between two transceivers;
receiving first data-encoded light transmitted across the free space optical path and applying the adaptive optics wavefront correction to at least partially correct a phase of a wavefront of the first data-encoded light;
optically attenuating the first data-encoded light;
detecting an average power level of the attenuated light;
generating a voltage that is approximately a log function of an average power level of the attenuated light;
varying the optical attenuation approximately as an exponential function of the voltage to adaptively regulate the power level of the first data-encoded light in response to time-varying losses along the free space optical path; and
applying the adaptive optics wavefront correction to at least partially pre-correct a phase of a wavefront of second light and transmitting the second light across the free space optical path.

13. A transceiver for adaptive optics free space optical communication across a free space optical path comprising:
an adaptive optics system for determining an adaptive optics wavefront correction in response to aberrations along a free space optical path between two transceivers, for applying the adaptive optics wavefront correction to at least partially correct a phase of a wavefront of first data-encoded light received across lire free space optical path, and further for applying the adaptive optics wavefront correction to at least partially pre-correct a phase of a wavefront of second light to be transmitted across the free space optical path; and
an adaptive optical power regulator for adaptively regulating a power level of the first data-encoded light in response to variations in a loss of the free space optical path, the adaptive optical power regulator comprising:
a variable optical attenuator having a controllable attenuation for optically attenuating the first data-encoded light; an
optical tap detector positioned, to detect the average power level of the attenuated light, the optical tap detector generating a voltage that is approximately a log function of the average power level of the attenuated light; and
a controller coupled to the optical tap detector and the variable optical attenuator, the controller varying the optical attenuation approximately as an exponential function of the voltage to adaptively regulate the optical attenuation in response to the detected average power level.

14. A system, comprising:
a free-space optical communications terminal; and
means for automatically regulating received power in an optical fiber, wherein said means is connected to said free-space optical communications terminal.

15. The system of claim 14, wherein said means comprises a semiconductor optical amplifier (SOA).

16. The system of claim 15, wherein said semiconductor optical amplifier is configured to operate as a passive power controller, without an active feedback controller.

17. The system of claim 14, wherein said means comprises a variable optical attenuator (VOA).

18. The system of claim 17, wherein said VOA is configured to operate on multimode optical fiber.

19. The system of claim 14, wherein said means utilizes received, power feedback

20. The system of claim 19, wherein said received power feedback is derived from a fiber-optic power splitter and a photodetector.

21. The system of claim 19, wherein said received power feedback is derived from a measurement of photocurrent in a communications photoreceiver.

22. The system of claim 14, further comprising an active regulator circuit having a feedback controller that monitors received power and modulates said means.
